(19) United States
(12) Patent Application Publication
(10) Pub. No.: US 2023/0174310 A1
(43) Pub. Date: Jun. 8, 2023

(54) HIGH ANTI-STATIC RUBBER TYPE POLYAMIDE PLATE BASED CONVEYING FLAT BELT WITHOUT BURRS AND PREPARATION METHOD THEREOF

(71) Applicant: Dongguan Dongji New Materials Belt Technology Co., Dongguan City (CN)

(72) Inventor: Jianjun Chen, Dongguan City (CN)

(73) Assignee: Dongguan Dongji New Materials Belt Technology Co., Dongguan City, Guangdong Province (CN)

(21) Appl. No.: 17/826,051

(22) Filed: May 26, 2022

(30) Foreign Application Priority Data
Dec. 6, 2021 (CN) 202111482413.4

(51) Int. Cl. B65G 15/34; C08J 3/18; C08J 5/18

(52) U.S. Cl. CPC B65G 15/34; C08J 3/18; C08J 5/18; C08J 2321/00

(57) ABSTRACT

Disclosed is a high anti-static rubber type polyamide plate based conveying flat belt without burrs and a preparation method thereof. The conveying flat belt includes a top layer, an upper rubber surface coating, a plate base upper side coating, a main body layer, a plate base lower side coating, a lower rubber surface coating, and a bottom layer.

### CROSS REFERENCE TO RELATED APPLICATION

This application claims the benefit and priority of Chinese Patent Application No. 202111482413.4, entitled “High anti-static rubber type polyamide plate based conveying flat belt without burrs and preparation method thereof” filed on Dec. 6, 2021, the disclosure of which is incorporated by reference herein in its entirety as part of the present application.

### TECHNICAL FIELD

The present disclosure relates to the technical field of the production of conveying flat belts, and in particular to a high anti-static rubber type polyamide plate based conveying flat belt without burrs and a preparation method thereof.

### BACKGROUND ART

Rubber type polyamide plate based flat belts take a polyamide plate base as a skeleton tensile body, and in the structure thereof, two layers of nylon cloth are necessary for frictioning and calendering. However, during application, loose fabric may generate burrs on both sides thereof, which may cause serious production and safety defects on high-precision machines that are sensitive to burrs. Materials of the skeleton tensile layer of the polyamide plate based flat belt are mainly nylon plate base polyamide 6 (PA6). The nylon plate base PA6 has a disadvantage of easily being affected by environmental temperature and humidity, and having poor weather resistance, which often causes instability of flat belts in size and length, and deformation of flat belts, and thus it needs to be adjusted several times before it can run. Synthetic rubber materials on a surface of the rubber type polyamide plate based flat belts are mainly nitrile butadiene rubber. The nitrile butadiene rubber has a medium wear resistance, and has a disadvantage of easily generating powder when frictionated, making it unsuitable to use in a dust-free workshop and a clean room.

### SUMMARY

In view of the defects in the above technologies, an object of the present disclosure is to provide a high anti-static rubber type polyamide plate based conveying flat belt without burrs and a preparation method thereof.

In order to achieve the above object, the present disclosure provides a high anti-static rubber type polyamide plate based conveying flat belt without burrs, including a top layer, an upper rubber surface coating, a plate base upper side coating, a main body layer, a plate base lower side coating, a lower rubber surface coating, and a bottom layer, wherein the top layer is bonded with the upper rubber surface coating by a first binder between a lower surface of the top layer and an upper surface of the upper rubber surface coating, the upper rubber surface coating is bonded with the plate base upper side coating by a second binder between a lower surface of the upper rubber surface coating and an upper surface of the plate base upper side coating, the plate base upper side coating is bonded with the main body layer by a third binder between a lower surface of the plate base upper side coating and an upper surface of the main body layer, the main body layer is bonded with the plate base lower side coating by a fourth binder between a lower surface of the main body layer and an upper surface of the plate base lower side coating, the plate base lower side coating is bonded with the lower rubber surface coating by a fifth binder between a lower surface of the plate base lower side coating and an upper surface of the lower rubber surface coating, and the lower rubber surface coating is bonded with the bottom layer by a sixth binder between a lower surface of the lower rubber surface coating and an upper surface of the bottom layer.

In some embodiments, both the top layer and the bottom layer are made of a modified nitrile butadiene rubber.

In some embodiments, both the upper rubber surface coating and the lower rubber surface coating are made by coating with a nitrile butadiene rubber binder.

In some embodiments, both the plate base upper side coating and the plate base lower coating are made by coating with a resin binder.

In some embodiments, the main body layer is made of a modified polyamide material.

In some embodiments, the upper rubber surface coating and the lower rubber surface coating have the same thickness, and the plate base upper side coating and the plate base lower side coating have the same thickness.

The present disclosure further provides a method for preparing the high anti-static rubber type polyamide plate based conveying flat belt without burrs, comprising the following steps:

step 1, providing a rubber formulation, and formulating required raw materials according to the rubber formulation to obtain a mixture of raw materials;

step 2, plastication: plasticating the mixture of raw materials using a two-stage plasticating process with a roller spacing of 0.8-1.0 mm, a capacity of 10 kg/batch and a temperature of not greater than 60° C.;

step 3, mixing: mixing a plastic with a stabilizer and a plasticizer to obtain a mixture, pre-plasticizing the mixture for a period of not less than 45 min to obtain a pre-plasticized plastic; plasticizing the pre-plasticized plastic into a uniform transparent sheet in a high-temperature plastic refining machine at a temperature of 150±5° C.; quickly mixing a rubber with the transparent sheet to generate a 10-15 mm thick sheet from the plastic refining machine; cooling the 10-15 mm thick sheet to ambient temperature, then rolling up the cooled 10-15 mm thick sheet, and standing for 8 h before use; refining the resulting product in an internal mixer with three stages at a temperature of 155±5° C. for 1.5 min, 1.5 min and 2 min, respectively, making three thin mixed plastic-rubber sheets with triangle shape on an open mill, to output an another 10-15 mm thick sheet; mixing by operating strictly according to a feeding sequence, and during the mixing on an open mill, reacting a blend of rubber and plastic in the presence of fillers and an additive, to form an 8-15 mm thick sheet, the fillers comprising one or more of sulfur, zinc oxide, stearic acid, an antioxidant, and white carbon black, and the additive comprising an accelerator; outputting, and spreading out a mixed rubber, cooling to ambient temperature, rolling up, and standing for more than 8 h before use;

step 4, frictioning: performing a frictioning on a nylon cloth with the mixed rubber to obtain a rubberized cloth, wherein before the frictioning, the nylon cloth is dried by a cloth drying machine, rolled up, and controlled to have a moisture content of not larger than 2%, the nylon cloth is dried when it is needed to be used in the frictioning, and the dried cloth is aligned when rolling up; in order to ensure the plasticity of the mixed rubber after the frictioning, the mixed rubber is subjected to a hot-refining comprising a rough refining and a fine refining, wherein the rough refining is performed by using a thin passing operation with a small roller spacing, and the fine refining is performed by softening at a high temperature of 40-60° C. and continuously cutting rolls, and during the hot-refining, each of temperature and color of the mixed rubber is consistent; when outputting rolls, an amount of the mixed rubber used in a calender is controlled such that rolls are not excessively output and be overstocked, which may cause reduced temperature of the mixed rubber and affect the frictioning; a thickness of the rubberized cloth is controlled to be uniform and have a difference of not larger than 0.1 mm; the surface of the rubberized cloth does not have wrinkles, not lack rubber cement and is not damaged by rolling, and remaining mixed rubber on both sides of the rubberized cloth is removed as much as possible; after the frictioning, the rubberized cloth is rolled up, and specifically the rubberized cloth after the frictioning is subjected to a cooling roller and then rolled up to obtain a rubberized cloth roll, during which both sides of the rubberized cloth are ensured aligned; after rolling, a product name, specification and production date are marked on the rubberized cloth roll;

step 5, vulcanization: vulcanizing the rubberized cloth on a drum vulcanizing machine at a temperature of 155±5° C. at a pressure of 10 MPa, and at a speed of 7 m/h which is consistent with that of a conventional tape 407, wherein two rubberized cloths are subjected to the vulcanization side by side, during which the two rubberized cloths are kept smooth and uniform; then outputting the resulting product from the drum vulcanizing machine, peeling off a pattern pad cloth from a surface of each rubberized cloth, and rolling up and aligning the rubberized cloths without wrinkling or overlapping;

step 6, preparation of a rubber cement:

preparing a rubber cement A by adding mixed rubber strips obtained by cutting the mixed rubber into small strips and ethyl acetate into a reactor according to a proportion, starting stirring, keeping the reactor at a temperature of 56-62° C. and stirring for 8-12 h, outputting the resulting material by filtering using a filter screen to obtain the rubber cement A; and

preparing a rubber cement B by adding ethanol into a reactor, starting stirring, slowly adding nylon particles thereto to obtain a mixture of ethanol and nylon particles, heating the mixture of ethanol and nylon particles to a temperature of 60-70° C., dissolving the nylon particles to obtain a nylon ethanol solution, and then slowly adding a solvent into the nylon ethanol solution, the solvent being formaldehyde, reacting at a temperature of 60-70° C. for 2 h, cooling, putting into an aluminum bucket, rinsing with cold water, and separating to obtain a precipitate, then pouring the precipitate into an aluminum pan, naturally drying, and then preparing a semi-finished product solution with a certain concentration by using the dried precipitate for later use, and then preparing an epoxy resin solution by dissolving epoxy resin into ethanol according to a certain concentration at a temperature of 50-60° C. to obtain an epoxy resin solution, mixing the semi-finished product solution and the epoxy resin solution in a certain ratio at a temperature of 40-50° C., stirring to be uniform, and adding accelerator H, i.e., hexamethylenetetramine after a little degree of cooling, and then stirring to be uniform for use;

step 7, formulation: formulating the high anti-static rubber type polyamide plate based conveying flat belt without burrs to have characteristics as follows:

under conditions that a strip plate has a thickness of 0.8 mm and the rubberized cloth has a total thickness of 0.45 mm, a plate base has a thickness of 0.2 mm, a single-sided coating of the rubber cement B on a surface of the plate base has a thickness of 0.05 mm, and a single-sided coating of the rubber cement A on a rubber surface has a thickness of 0.05 mm; under conditions that a strip plate has a thickness of 1.0 mm and the rubberized cloth has a total thickness of 0.3 mm, a plate base has a thickness of 0.2 mm, a single-sided coating of the rubber cement B on a surface of the plate base has a thickness of 0.05 mm, and a single-sided coating of the rubber cement A on a rubber surface has a thickness of 0.05 mm; under conditions that a strip plate has a thickness of 1.2 mm and the rubberized cloth has a total thickness of 0.55 mm, a plate base has a thickness of 0.4 mm, a single-sided coating of the rubber cement B on a surface of the plate base has a thickness of 0.05 mm, and a single-sided coating of the rubber cement A on a rubber surface has a thickness of 0.05 mm;

under conditions that a strip plate has a thickness of 1.5 mm and the rubberized cloth has a total thickness of 0.55 mm, a plate base has a thickness of 0.5 mm, a single-sided coating of the rubber cement B on a surface of the plate base has a thickness of 0.1 mm, and a single-sided coating of the rubber cement A on a rubber surface has a thickness of 0.1 mm;

under conditions that a strip plate has a thickness of 1.8 mm and the rubberized cloth has a total thickness of 0.7 mm, a plate base has a thickness of 0.6 mm, a single-sided coating of the rubber cement B on a surface of the plate base has a thickness of 0.1 mm, and a single-sided coating of the rubber cement A on a rubber surface has a thickness of 0.1 mm; and

under conditions that a strip plate has a thickness of 2.0 mm and the rubberized cloth has a total thickness of 0.7 mm, a plate base has a thickness of 0.8 mm, a single-sided coating of the rubber cement B on a surface of the plate base has a thickness of 0.1 mm, and a single-sided coating of the rubber cement A on a rubber surface has a thickness of 0.1 mm;

step 8, coating: coating a rubber surface of the rubberized cloth with the rubber cement A to obtain a rubber cement layer, drying in an oven at a temperature of 90-110° C. to ensure the rubber cement layer to be dried, wherein when coating, the coating on the rubber surface is uniform and complete without disadvantages of lacking rubber cement and having excessive rubber cement in some areas, a cloth surface of the rubberized cloth is kept as clean as possible without sticking any rubber cement thereon; after taking out the rubberized cloth from the oven, covering the rubberized cloth with a plastic film and then aligning and rolling up, wherein in principle, the rubberized cloth is coated when needed to be used; after coating the rubber surface of the rubberized cloth, coating a plate base with the rubber cement B and pre-compounding, wherein before coating the plate base with the rubber cement B, the plate base is modified, then cleaned with acetone, and dried, and the plate base is coated with the rubber cement B at a temperature of 90-110° C., and the rubber cement B is ensured to be dried in an oven, wherein when coating with the rubber cement B, the upper side surface and lower side surface of the plate base is coated uniformly and completely; after taking out the plate base, covering the plate base with the rubberized cloth with the rubber side of the rubberized cloth contacting with the plate base; pre-compounding with three layers up and down aligned, wherein the rubberized cloth covers the plate base; after pre-compounding, subjecting to the resulting product to an aligning, a rolling up, and a standing for use with a general storage period of not exceeding three days;

step 9, compounding in a drum vulcanizer, wherein the compounding is performed in a continuous production line, during which a belt body is kept in a tensioned state, and a surface of the belt body is kept clean and smooth, and the last vulcanized batch is fully cooled, and then a pressure is reduced and the belt body is relaxed, and the resulting product is output from the drum vulcanizer after continuously compounding, and the nylon cloth for frictioning on a surface is peeled off;

step 10, cutting, which comprises straightening edges, cutting, and grinding joints by a machine, wherein when straightening edges, one side of the plate base is taken as a reference, a base edge of the belt body is carefully trimmed; when cutting, the base edge is taken as a reference, a cutting is performed according to required sizes, wherein a width is allowed to be 0.2 mm smaller than required width, and a length is accurately measured, a joint line is drawn at an angle of 60° according to the thickness and width of the belt body; when grinding joints by a machine, the belt body is leveled, and an inclined surface is kept flat and uniform in thickness, and when two joints are closed, they match each other, a plate base of one joint matches with a plate base of the other joint, and a rubber of one joint matches with a rubber of another joint, a thickness of a joint is not lower than a belt body itself, and is allowed to exceed the belt body by 0.2 mm;

step 11, jointing by a binder: cleaning joints, coating corresponding binders on a rubber surface and a plate base surface respectively, naturally drying, and then aligning and cold-pressing, wherein when aligning joints, each part is aligned, and joints do not overlap too much or too little, and a straightness is ensured; after outputting joints from a machine, cleaning and tidying the joints to ensure that the joints are clean and beautiful; and

step 12, finally, checking and storing: printing a manufacturer's name or trademark, a product model, size, production date, and transferring destination on the belt body, checking by a checker, and then packaging and storing.

In summary, in the present disclosure, the high anti-static rubber type polyamide plate based conveying flat belt without burrs and the preparation method thereof have the following advantages:

1. They subvert the structural design and production process of the conventional polyamide plate base flat belt, make a revolutionary change by abandoning a layer of an inner fabric cloth, and completely solve the problem of burrs presenting in the use of a conventional rubber-type polyamide plate based flat belt.

2. They involve a modifying treatment of the conventional polyamide plate base, which improves the flexibility and weather resistance of the plate base, and meanwhile, improves the tensile strength of the plate base by 30% or more and reduces the elongation by 10% or more, making the high anti-static rubber type polyamide plate based conveying flat belt without burrs of the present disclosure meet requirements for smaller wheel diameter and higher temperature environment.

3. In the present disclosure, the nitrile butadiene rubber formulation of the conveying layer on the top surface and the friction layer on the bottom surface of the flat belt has been improved and upgraded, thus ensuring no powder will generate when frictionated and the permanent high anti-static requirements are met in the application conditions.

### BRIEF DESCRIPTION OF THE DRAWINGS

FIG. 1 shows a schematic structural diagram according to an embodiment of the present disclosure.

FIG. 2 shows a process flow diagram according to an embodiment of the present disclosure.

### REFERENCE SIGNS IN THE DRAWINGS

In the figures, 1 represents a top layer, 2 represents an upper rubber surface coating, 3 represents a plate base upper side coating, 4 represents a main body layer, 5 represents a plate base lower side coating, 6 represents a lower rubber surface coating, and 7 represents a bottom layer.

### DETAILED DESCRIPTION OF THE EMBODIMENTS

The technical solutions in the embodiments of the present disclosure will be clearly and completely described below with reference to the accompanying drawings of the present disclosure. Obviously, the described embodiments are only a part of the embodiments of the present disclosure, but not all of the embodiments. Based on the embodiments of the present disclosure, all other embodiments obtained by those of ordinary skill in the art without creative labors shall fall within the protection scope of the present disclosure.

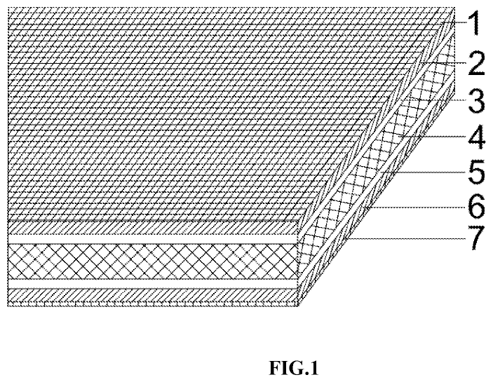

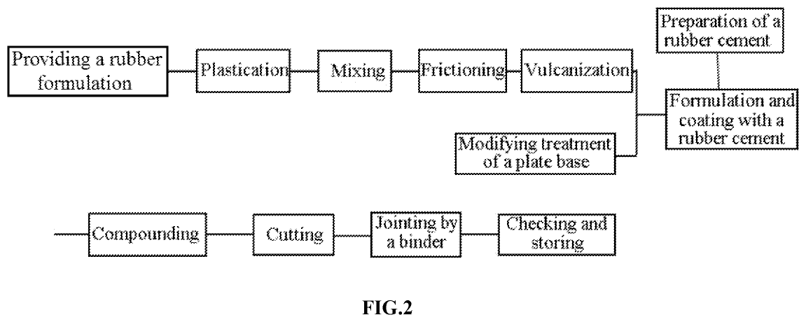

As shown in FIGS. 1 and 2, a high anti-static rubber type polyamide plate based conveying flat belt without burrs includes a top layer 1, an upper rubber surface coating 2, a plate base upper side coating 3, a main body layer 4, a plate base lower side coating 5, a lower rubber surface coating 6, and a bottom layer 7, wherein the top layer 1 is bonded with the upper rubber surface coating 2 by a first binder between a lower surface of the top layer 1 and an upper surface of the upper rubber surface coating 2, the upper rubber surface coating 2 is bonded with the plate base upper side coating 3 by a second binder between a lower surface of the upper rubber surface coating 2 and an upper surface of the plate base upper side coating 3, the plate base upper side coating 3 is bonded with the main body layer 4 by a third binder between a lower surface of the plate base upper side coating 3 and an upper surface of the main body layer 4, the main body layer 4 is bonded with the plate base lower side coating 5 by a fourth binder between a lower surface of the main body layer 4 and an upper surface of the plate base lower side coating 5, the plate base lower side coating 5 is bonded with the lower rubber surface coating 6 by a fifth binder between a lower surface of the plate base lower side coating 5 and an upper surface of the lower rubber surface coating 6, and the lower rubber surface coating 6 is bonded with the bottom layer 7 by a sixth binder between a lower surface of the lower rubber surface coating 6 and an upper surface of the bottom layer 7.

In some embodiments, both the top layer 1 and the bottom layer 7 are made of a modified nitrile butadiene rubber.

In some embodiments, both the upper rubber surface coating 2 and the lower rubber surface coating 6 are made by coating with a nitrile butadiene rubber binder.

In some embodiments, both the plate base upper side coating 3 and the plate base lower coating 5 are made by coating with a resin binder.

In some embodiments, the main body layer 4 is made of a modified polyamide material.

In some embodiments, the upper rubber surface coating 2 and the lower rubber surface coating 6 have the same thickness, and the plate base upper side coating 3 and the plate base lower side coating 5 have the same thickness.

A method for preparing the high anti-static rubber type polyamide plate based conveying flat belt without burrs, comprises the following steps:

step 1, a rubber formulation is provided, and required raw materials according to the rubber formulation are formulated to obtain a mixture of raw materials;

step 2, plastication: the mixture of raw materials is plasticated using a two-stage plasticating process with a roller spacing of 0.8-1.0 mm, a capacity of 10 kg/batch and a temperature of not greater than 60° C.;

step 3, mixing: a plastic is mixed with a stabilizer and a plasticizer to obtain a mixture, the mixture is pre-plasticized for a period of not less than 45 min to obtain a pre-plasticized plastic; the pre-plasticized plastic is plasticized into a uniform transparent sheet in a high-temperature plastic refining machine at a temperature of 150±5° C.; a rubber is quickly mixed with the transparent sheet, and a 10-15 mm thick sheet is generated from the plastic refining machine; the 10-15 mm thick sheet is cooled to ambient temperature, then rolled up, and stood for 8 h before use; a refining is performed in an internal mixer with three stages at a temperature of 155±5° C. for 1.5 min, 1.5 min and 2 min, respectively, three thin mixed plastic-rubber sheets with triangle shape are made on an open mill, to output an another 10-15 mm thick sheet; a mixing is performed by operating strictly according to a feeding sequence, and during the mixing on an open mill, a blend of rubber and plastic is reacted in the presence of fillers and an additive, to form an 8-15 mm thick sheet, wherein the fillers comprising one or more of sulfur, zinc oxide, stearic acid, an antioxidant, and white carbon black, and the additive comprises an accelerator; after outputting, a mixed rubber is spread out, cooled to ambient temperature, rolled up, and stood for not less than 8 h before use;

step 4, frictioning: a frictioning is performed on a nylon cloth to obtain a rubberized cloth, wherein before the frictioning, the nylon cloth is dried by a cloth drying machine, rolled up, and controlled to have a moisture content of not larger than 2%, the nylon cloth is dried when it is needed to be used in the frictioning, and the dried cloth is aligned when rolling up; in order to ensure the plasticity of the mixed rubber after the frictioning, the mixed rubber is subjected to a hot-refining comprising a rough refining and a fine refining, wherein the rough refining is performed by using a thin passing operation with a small roller spacing, and the fine refining is performed by softening at a high temperature of 40-60° C. and continuously cutting rolls, and during the hot-refining, each of temperature and color of the rubber is consistent; when outputting rolls, an amount of the mixed rubber used in a calender is controlled such that rolls are not excessively output and be overstocked, which may cause reduced temperature of the mixed rubber and affect the frictioning; the thickness of the rubberized cloth is controlled to be uniform and have a difference of not larger than 0.1 mm; the surface of the rubberized cloth does not have wrinkles, not lack rubber cement and not be damaged by rolling, and remaining mixed rubber on both sides of the rubberized cloth is removed as much as possible; after the frictioning, the rubberized cloth is rolled up, and specifically the rubberized cloth after the frictioning is subjected to a cooling roller and then rolled up to obtain a rubberized cloth roll, during which both sides of the rubberized cloth are ensured aligned; after rolling, a product name, specification and production date are marked on the rubberized cloth roll;

step 5, vulcanization: the rubberized cloth is vulcanized on a drum vulcanizing machine at a temperature of 155±5° C. at a pressure of 10 MPa, and at a speed of 7 m/h which is consistent with that of a conventional tape 407, wherein two rubberized cloths are subjected to the vulcanization side by side, during which the two rubberized cloths are kept smooth and uniform; after outputting from the drum vulcanizing machine, a pattern pad cloth is peeled from a surface of each rubberized cloth, the rubberized cloths are rolled up and aligned without wrinkling or overlapping;

step 6, preparation of a rubber cement:

a rubber cement A is prepared by the following steps: mixed rubber strips obtained by cutting the mixed rubber into small strips and ethyl acetate are added into a reactor according to a proportion, then a stirring is started, the reactor is kept at a temperature of 56-62° C. and the stirring is performed for 8-12 h, the resulting material is filtered using a filter screen to obtain the rubber cement A; and

a rubber cement B is prepared by the following steps: ethanol is added into a reactor, then a stirring is started, nylon particles are slowly added thereto to obtain a mixture of ethanol and nylon particles, the mixture of ethanol and nylon particles is heated to a temperature of 60-70° C. and the nylon particles are dissolved to obtain a nylon ethanol solution, and then a solvent is slowly added into the nylon ethanol solution, the solvent being formaldehyde, a reaction is performed at a temperature of 60-70° C. for 2 h, and the mixture obtained after the reaction is cooled, put into an aluminum bucket, rinsed with cold water, and separated to obtain a precipitate, and then the precipitate is poured into an aluminum pan, and naturally dried, and then a semi-finished product solution with a certain concentration is prepared by using the dried precipitate for later use, and then an epoxy resin solution is prepared by dissolving epoxy resin into ethanol according to a certain concentration at a temperature of 50-60° C. to obtain an epoxy resin solution, then the semi-finished product solution and the epoxy resin solution are mixed in a certain ratio at a temperature of 40-50° C., and stirred to be uniform, and accelerator H (i.e., hexamethylenetetramine) is added after a little degree of cooling, and then the resulting system is stirred to be uniform for use;

step 7, formulation: the high anti-static rubber type polyamide plate based conveying flat belt without burrs is formulated to have characteristics as follows:

under conditions that a strip plate has a thickness of 0.8 mm and the rubberized cloth has a total thickness of 0.45 mm, a plate base has a thickness of 0.2 mm, a single-sided coating of the rubber cement B on a surface of the plate base has a thickness of 0.05 mm, and a single-sided coating of the rubber cement A on a rubber surface has a thickness of 0.05 mm;

under conditions that a strip plate has a thickness of 1.0 mm and the rubberized cloth has a total thickness of 0.3 mm, a plate base has a thickness of 0.2 mm, a single-sided coating of the rubber cement B on a surface of the plate base has a thickness of 0.05 mm, and a single-sided coating of the rubber cement A on a rubber surface has a thickness of 0.05 mm;

under conditions that a strip plate has a thickness of 1.2 mm and the rubberized cloth has a total thickness of 0.55 mm, a plate base has a thickness of 0.4 mm, a single-sided coating of the rubber cement B on a surface of the plate base has a thickness of 0.05 mm, and a single-sided coating of the rubber cement A on a rubber surface has a thickness of 0.05 mm;

under conditions that a strip plate has a thickness of 1.5 mm and the rubberized cloth has a total thickness of 0.55 mm, a plate base has a thickness of 0.5 mm, a single-sided coating of the rubber cement B on a surface of the plate base has a thickness of 0.1 mm, and a single-sided coating of the rubber cement A on a rubber surface has a thickness of 0.1 mm;

under conditions that a strip plate has a thickness of 1.8 mm and the rubberized cloth has a total thickness of 0.7 mm, a plate base has a thickness of 0.6 mm, a single-sided coating of the rubber cement B on a surface of the plate base has a thickness of 0.1 mm, and a single-sided coating of the rubber cement A on a rubber surface has a thickness of 0.1 mm;

under conditions that a strip plate has a thickness of 2.0 mm and the rubberized cloth has a total thickness of 0.7 mm, a plate base has a thickness of 0.8 mm, a single-sided coating of the rubber cement B on a surface of the plate base has a thickness of 0.1 mm, and a single-sided coating of the rubber cement A on a rubber surface has a thickness of 0.1 mm;

| Thickness of | Total thickness of | Thickness | Thickness of the single-sided | Thickness of the single-sided |
|---|---|---|---|---|
| the strip | the rubberized | of the plate | coating of the rubber cement B | coating of the rubber cement A |
| plate | cloth | base | on a surface of the plate base | on a surface of the plate base |
| (mm) | (mm) | (mm) | (mm) | (mm) |
| 0.8 | 0.45 mm 210 | 0.2 | 0.05 | 0.05 |
| | rubberized cloth | | | |
| 1.0 | 0.45 mm 210 | 0.3 | 0.05 | 0.05 |
| | rubberized cloth | | | |
| 1.2 | 0.55 mm 210 | 0.4 | 0.05 | 0.05 |
| | rubberized cloth | | | |
| 1.5 | 0.55 mm 210 | 0.5 | 0.1 | 0.1 |
| | rubberized cloth | | | |
| 1.8 | 0.7 mm 280 | 0.6 | 0.1 | 0.1 |
| | rubberized cloth | | | |
| 2.0 | 0.7 mm 280 | 0.8 | 0.1 | 0.1 |
| | rubberized cloth | | | |

step 8, coating: a rubber surface of the rubberized fabric is coated with the rubber cement A, and dried in an oven at a temperature of 90-110° C., to ensure that the obtained rubber cement layer is dried, wherein when coating, the coating on the rubber surface is uniform and complete without disadvantages of lacking rubber cement and having excessive rubber cement in some areas, a cloth surface of the rubberized cloth is be kept as clean as possible without sticking any rubber cement thereon; after taking out the rubberized cloth from the oven, the rubberized cloth is covered with a plastic film and then aligned and rolled up, wherein in principle, the rubberized cloth is coated when needed to be used; after coating the rubber surface of the rubberized cloth, a plate base is coated with the rubber cement B and pre-compounded, wherein before coating the plate base with the rubber cement B, the plate base is modified, then cleaned with acetone, and dried, and the plate base is coated with the rubber cement B at a temperature of 90-110° C., and the rubber cement B is ensured to be dried, wherein when coating the rubber cement B, an upper side surface and lower side surface of the plate base are coated uniformly and completely; after taking out the plate base, the plate base is covered by the rubberized cloth with the rubber side of the rubberized cloth contacting with the plate base; three layers up and down are aligned and pre-compounded, wherein the rubberized cloth covers the plate base; after pre-compounding, the resulting product is aligned, rolled up, and stood for use with a general storage period of not exceeding three days;

| | | | Set | Set |
|---|---|---|---|---|
| Type of the | Thickness | Temperature | frequency | pressure |
| conveying belt | (mm) | (° C.) | (HZ) | (MPa) |
| Rubber type without | 0.8 | 110-130 | 17 | 8 |
| a base cloth | 1.0 | 110-130 | 17 | 8 |
| | 1.2 | 120-130 | 15 | 9 |
| | 1.5 | 130-150 | 13 | 10 |
| | 1.8 | 150-160 | 13 | 11 |
| | 2.0 | 150-170 | 13 | 12 |

step 9, a compounding is performed in a drum vulcanizer, wherein the compounding is performed in a continuous production line, during which a belt body is kept in a tensioned state, and a surface of the belt body is kept clean and smooth, and the last vulcanized batch is fully cooled, and then a pressure is reduced and the belt body is relaxed, the resulting product is output from the drum vulcanizer after continuously compounding, and a cloth surface for frictioning on a surface is peeled off;

| | | | | | | |
|---|---|---|---|---|---|---|
| thickness of the conveying belt (mm) | 0.8 | 1.0 | 1.2 | 1.5 | 1.8 | 2.0 |
| Length of a joint (mm) | 20 | 25 | 30 | 35 | 40 | 50 |

step 10, a cutting is performed, wherein the cutting comprises straightening edges, cutting, and grinding joints by a machine, wherein when straightening edges, one side of the plate base is taken as a reference, a base edge of a belt body is carefully trimmed; when cutting, the base edge is taken as a reference, and the cutting is performed according to required sizes, wherein generally, a width is allowed to be 0.2 mm smaller than required width, and a length is accurately measured, a joint line is drawn at an angle of 60° according to the thickness and width of the belt body; when grinding joints by a machine, the belt body is leveled, and an inclined surface is kept flat and uniform in thickness, and when two joints are closed, they match each other, a plate base of one joint matches with a plate base of the other joint, and a rubber of one joint matches with a rubber of another joint, a thickness of a joint is not be lower than a belt body itself, and is allowed to exceed the belt body by 0.2 mm;

step 11, jointing by a binder: joints are cleaned, and corresponding binders are coated on a rubber surface and a plate base surface respectively, naturally dried, and then aligned and cold-pressed, wherein when aligning joints, each part is aligned, and joints do not overlap too much or too little, and a straightness is ensured; after outputting joints from a machine, the joints are cleaned and tidied to ensure that the joints are clean and beautiful;

| | Preservation | Preservation | | Output |
|---|---|---|---|---|
| Type of the | temperature | time | Pressure | temperature |
| conveying belt | (° C.) | (min) | (MPa) | (° C.) |
| Rubber type without | 100-120 | 30 | 8~15 | 40 or less |
| a base cloth | | | | |

step 12, finally, checking and storing: a manufacturer's name or trademark, a product model, size, production date, and transferring destination are printed on the belt body, and the product is checked by a checker, and then packaged and stored.

In summary, in the present disclosure, the high anti-static rubber type polyamide plate based conveying flat belt without burrs and the preparation method thereof have the following advantages:

1. They subvert the structural design and production process of the conventional polyamide plate base flat belt, make a revolutionary change by abandoning a layer of an inner fabric cloth, and completely solve the problem of burrs presenting in the use of a conventional rubber-based polyamide plate base flat belt.

2. They involve a modifying treatment of the conventional polyamide plate base, which improves the flexibility and weather resistance of the plate base, and meanwhile, improves the tensile strength of the plate base by 30% or more and reduces the elongation by 10% or more, making the high anti-static rubber type polyamide plate based conveying flat belt without burrs of the present disclosure meet requirements for smaller wheel diameter and higher temperature environment.

3. In the present disclosure, the nitrile butadiene rubber formulation of the conveying layer on the top surface and the friction layer on the bottom surface of the flat belt has been improved and upgraded, thus ensuring no powder will generate when frictionated and the permanent high anti-static requirements are met in the application conditions.

It is obvious to those skilled in the art that the present disclosure is not limited to the details of the above exemplary embodiments, but could be implemented in other specific forms without departing from the principle or essential characteristics of the present disclosure. Therefore, the embodiments should be regarded as illustrative and non-limited in all respects. The scope of the present disclosure is defined by the appended claims rather than the above description, and therefore all changes that fall within the meaning and range of equivalents of the claims are intended to be included in the present disclosure. Any reference signs in the claims shall not be regarded as limiting the claims involved.

In addition, it should be understood that although this description is described in terms of embodiments, each embodiment does not only contain an independent technical solution. This describing means of the description is only for the sake of clarity. Those skilled in the art shall take the description as a whole, and the technical solutions in each embodiment could also be appropriately combined to form other embodiments that could be understood by those skilled in the art.

What is claimed is:

1. A high anti-static rubber type polyamide plate based conveying flat belt without burrs, comprising a top layer, an upper rubber surface coating, a plate base upper side coating, a main body layer, a plate base lower side coating, a lower rubber surface coating, and a bottom layer,
wherein the top layer is bonded with the upper rubber surface coating by a first binder between a lower surface of the top layer and an upper surface of the upper rubber surface coating, the upper rubber surface coating is bonded with the plate base upper side coating by a second binder between a lower surface of the upper rubber surface coating and an upper surface of the plate base upper side coating, the plate base upper side coating is bonded with the main body layer by a third binder between a lower surface of the plate base upper side coating and an upper surface of the main body layer, the main body layer is bonded with the plate base lower side coating by a fourth binder between a lower surface of the main body layer and an upper surface of the plate base lower side coating, the plate base lower side coating is bonded with the lower rubber surface coating by a fifth binder between a lower surface of the plate base lower side coating and an upper surface of the lower rubber surface coating, and the lower rubber surface coating is bonded with the bottom layer by a sixth binder between a lower surface of the lower rubber surface coating and an upper surface of the bottom layer.

2. The high anti-static rubber type polyamide plate based conveying flat belt without burrs of claim 1, wherein both the top layer and the bottom layer are made of a modified nitrile butadiene rubber.

3. The high anti-static rubber type polyamide plate based conveying flat belt without burrs of claim 1, wherein both the upper rubber surface coating and the lower rubber surface coating are made by coating with a nitrile butadiene rubber binder.

4. The high anti-static rubber type polyamide plate based conveying flat belt without burrs of claim 1, wherein both the plate base upper side coating and the plate base lower coating are made by coating with a resin binder.

5. The high anti-static rubber type polyamide plate based conveying flat belt without burrs of claim 1, wherein the main body layer is made of a modified polyamide material.

6. The high anti-static rubber type polyamide plate based conveying flat belt without burrs of claim 1, wherein the upper rubber surface coating and the lower rubber surface coating have the same thickness, and the plate base upper side coating and the plate base lower side coating have the same thickness.

7. A method for preparing the high anti-static rubber type polyamide plate based conveying flat belt without burrs of claim 1, comprising the following steps:
step 1, providing a rubber formulation, and formulating required raw materials according to the rubber formulation to obtain a mixture of raw materials;
step 2, plastication: plasticating the mixture of raw materials using a two-stage plasticating process with a roller spacing of 0.8-1.0 mm, a capacity of 10 kg/batch and a temperature of not greater than 60° C.;
step 3, mixing: mixing a plastic with a stabilizer and a plasticizer to obtain a mixture, pre-plasticizing the mixture for a period of not less than 45 min to obtain a pre-plasticized plastic; plasticizing the pre-plasticized plastic into a uniform transparent sheet in a high-temperature plastic refining machine at a temperature of 150±5° C.; quickly mixing a rubber with the transparent sheet to generate a 10-15 mm thick sheet from the plastic refining machine; cooling the 10-15 mm thick sheet to ambient temperature, then rolling up the cooled 10-15 mm thick sheet, and standing for 8 h before use; refining the resulting product in an internal mixer with three stages at a temperature of 155±5° C. for 1.5 min, 1.5 min and 2 min, respectively, making three thin mixed plastic-rubber sheets with triangle shape on an open mill, to output an another 10-15 mm thick sheet; mixing by operating strictly according to a feeding sequence, and during the mixing on an open mill, reacting a blend of rubber and plastic in the presence of fillers and an additive, to form an 8-15 mm thick sheet, the fillers comprising one or more of sulfur, zinc oxide, stearic acid, an antioxidant, and white carbon black, and the additive comprising an accelerator; outputting, and spreading out a mixed rubber, cooling to ambient temperature, rolling up, and standing for not less than 8 h before use;
step 4, frictioning: performing a frictioning on a nylon cloth with the mixed rubber to obtain a rubberized cloth, wherein before the frictioning, the nylon cloth is dried by a cloth drying machine, rolled up, and controlled to have a moisture content of not larger than 2%, the nylon cloth is dried when it is needed to be used in the frictioning, and the dried cloth is aligned when rolling up; in order to ensure the plasticity of the mixed rubber after the frictioning, the mixed rubber is subjected to a hot-refining comprising a rough refining and a fine refining, wherein the rough refining is performed by using a thin passing operation with a small roller spacing, and the fine refining is performed by softening at a high temperature of 40-60° C. and continuously cutting rolls, and during the hot-refining, each of temperature and color of the mixed rubber is consistent; when outputting rolls, an amount of the mixed rubber used in a calender is controlled such that rolls are not excessively output and be overstocked, which may cause reduced temperature of the mixed rubber and affect the frictioning; a thickness of the rubberized cloth is controlled to be uniform and have a difference of not larger than 0.1 mm; the surface of the rubberized cloth does not have wrinkles, not lack rubber cement and is not damaged by rolling, and remaining mixed rubber on both sides of the rubberized cloth is removed as much as possible; after the frictioning, the rubberized cloth is rolled up, and specifically the rubberized cloth after the frictioning is subjected to a cooling roller and then rolled up to obtain a rubberized cloth roll, during which both sides of the rubberized cloth are ensured aligned; after rolling, a product name, specification and production date are marked on the rubberized cloth roll;
step 5, vulcanization: vulcanizing the rubberized cloth on a drum vulcanizing machine at a temperature of 155±5° C. at a pressure of 10 MPa, and at a speed of 7 m/h which is consistent with that of a conventional tape 407, wherein two rubberized cloths are subjected to the vulcanization side by side, during which the two rubberized cloths are kept smooth and uniform; then outputting the resulting product from the drum vulcanizing machine, peeling off a pattern pad cloth from a surface of each rubberized cloth, and rolling up and aligning the rubberized cloths without wrinkling or overlapping;
step 6, preparation of a rubber cement:
preparing a rubber cement A by adding mixed rubber strips obtained by cutting the mixed rubber into small strips and ethyl acetate into a reactor according to a proportion, starting stirring, keeping the reactor at a temperature of 56-62° C. and stirring for 8-12 h, outputting the resulting material by filtering using a filter screen to obtain the rubber cement A; and
preparing a rubber cement B by adding ethanol into a reactor, starting stirring, slowly adding nylon particles thereto to obtain a mixture of ethanol and nylon particles, heating the mixture of ethanol and nylon particles to a temperature of 60-70° C., dissolving the nylon particles to obtain a nylon ethanol solution, and then slowly adding a solvent into the nylon ethanol solution, the solvent being formaldehyde, reacting at a temperature of 60-70° C. for 2 h, cooling, putting into an aluminum bucket, rinsing with cold water, and separating to obtain a precipitate, then pouring the precipitate into an aluminum pan, naturally drying, and then preparing a semi-finished product solution with a certain concentration by using the dried precipitate for later use, and then preparing an epoxy resin solution by dissolving epoxy resin into ethanol according to a certain concentration at a temperature of 50-60° C. to obtain an epoxy resin solution, mixing the semi-finished product solution and the epoxy resin solution in a certain ratio at a temperature of 40-50° C., stirring to be uniform, and adding accelerator H, i.e., hexamethylenetetramine after a little degree of cooling, and then stirring to be uniform for use;
step 7, formulation: formulating the high anti-static rubber type polyamide plate based conveying flat belt without burrs to have characteristics as follows:
under conditions that a strip plate has a thickness of 0.8 mm and the rubberized cloth has a total thickness of 0.45 mm, a plate base has a thickness of 0.2 mm, a single-sided coating of the rubber cement B on a surface of the plate base has a thickness of 0.05 mm, and a single-sided coating of the rubber cement A on a rubber surface has a thickness of 0.05 mm;
under conditions that a strip plate has a thickness of 1.0 mm and the rubberized cloth has a total thickness of 0.3 mm, a plate base has a thickness of 0.2 mm, a single-sided coating of the rubber cement B on a surface of the plate base has a thickness of 0.05 mm, and a single-sided coating of the rubber cement A on a rubber surface has a thickness of 0.05 mm;
under conditions that a strip plate has a thickness of 1.2 mm and the rubberized cloth has a total thickness of 0.55 mm, a plate base has a thickness of 0.4 mm, a single-sided coating of the rubber cement B on a surface of the plate base has a thickness of 0.05 mm, and a single-sided coating of the rubber cement A on a rubber surface has a thickness of 0.05 mm;
under conditions that a strip plate has a thickness of 1.5 mm and the rubberized cloth has a total thickness of 0.55 mm, a plate base has a thickness of 0.5 mm, a single-sided coating of the rubber cement B on a surface of the plate base has a thickness of 0.1 mm, and a single-sided coating of the rubber cement A on a rubber surface has a thickness of 0.1 mm;
under conditions that a strip plate has a thickness of 1.8 mm and the rubberized cloth has a total thickness of 0.7 mm, a plate base has a thickness of 0.6 mm, a single-sided coating of the rubber cement B on a surface of the plate base has a thickness of 0.1 mm, and a single-sided coating of the rubber cement A on a rubber surface has a thickness of 0.1 mm; and
under conditions that a strip plate has a thickness of 2.0 mm and the rubberized cloth has a total thickness of 0.7 mm, a plate base has a thickness of 0.8 mm, a single-sided coating of the rubber cement B on a surface of the plate base has a thickness of 0.1 mm, and a single-sided coating of the rubber cement A on a rubber surface has a thickness of 0.1 mm;
step 8, coating: coating a rubber surface of the rubberized cloth with the rubber cement A to obtain a rubber cement layer, drying in an oven at a temperature of 90-110° C. to ensure the rubber cement layer to be dried, wherein when coating, the coating on the rubber surface is uniform and complete without disadvantages of lacking rubber cement and having excessive rubber cement in some areas, a cloth surface of the rubberized cloth is kept as clean as possible without sticking any rubber cement thereon; after taking out the rubberized cloth from the oven, covering the rubberized cloth with a plastic film and then aligning and rolling up, wherein in principle, the rubberized cloth is coated when needed to be used; after coating the rubber surface of the rubberized cloth, coating a plate base with the rubber cement B and pre-compounding, wherein before coating the plate base with the rubber cement B, the plate base is modified, then cleaned with acetone, and dried, and the plate base is coated with the rubber cement B at a temperature of 90-110° C., and the rubber cement B is ensured to be dried in an oven, wherein when coating with the rubber cement B, the upper side surface and lower side surface of the plate base is coated uniformly and completely; after taking out the plate base, covering the plate base with the rubberized cloth with the rubber side of the rubberized cloth contacting with the plate base; pre-compounding with three layers up and down aligned, wherein the rubberized cloth covers the plate base; after pre-compounding, subjecting to the resulting product to an aligning, a rolling up, and a standing for use with a general storage period of not exceeding three days;
step 9, compounding in a drum vulcanizer, wherein the compounding is performed in a continuous production line, during which a belt body is kept in a tensioned state, and a surface of the belt body is kept clean and smooth, and the last vulcanized batch is fully cooled, and then a pressure is reduced and the belt body is relaxed, and the resulting product is output from the drum vulcanizer after continuously compounding, and the nylon cloth for frictioning on a surface is peeled off;
step 10, cutting, which comprises straightening edges, cutting, and grinding joints by a machine, wherein when straightening edges, one side of the plate base is taken as a reference, a base edge of the belt body is carefully trimmed; when cutting, the base edge is taken as a reference, a cutting is performed according to required sizes, wherein a width is allowed to be 0.2 mm smaller than required width, and a length is accurately measured, a joint line is drawn at an angle of 60° according to the thickness and width of the belt body; when grinding joints by a machine, the belt body is leveled, and an inclined surface is kept flat and uniform in thickness, and when two joints are closed, they match each other, a plate base of one joint matches with a plate base of the other joint, and a rubber of one joint matches with a rubber of another joint, a thickness of a joint is not lower than a belt body itself, and is allowed to exceed the belt body by 0.2 mm;
step 11, jointing by a binder: cleaning joints, coating corresponding binders on a rubber surface and a plate base surface respectively, naturally drying, and then aligning and cold-pressing, wherein when aligning joints, each part is aligned, and joints do not overlap too much or too little, and a straightness is ensured; after outputting joints from a machine, cleaning and tidying the joints to ensure that the joints are clean and beautiful; and
step 12, finally, checking and storing: printing a manufacturer's name or trademark, a product model, size, production date, and transferring destination on the belt body, checking by a checker, and then packaging and storing.

8. The method of claim 7, wherein both the top layer and the bottom layer are made of a modified nitrile butadiene rubber.

9. The method of claim 7, wherein both the upper rubber surface coating and the lower rubber surface coating are made by coating with a nitrile butadiene rubber binder.

10. The method of claim 7, wherein both the plate base upper side coating and the plate base lower coating are made by coating with a resin binder.

11. The method of claim 7, wherein the main body layer is made of a modified polyamide material.

12. The method of claim 7, wherein the upper rubber surface coating and the lower rubber surface coating have the same thickness, and the plate base upper side coating and the plate base lower side coating have the same thickness.
